(19) United States
(12) Patent Application Publication
(10) Pub. No.: US 2008/0246383 A1
(43) Pub. Date: Oct. 9, 2008

(54) LED-lamp heat-dissipation device

(76) Inventors: Kun-Jung Chang, Kaohsiung County (TW); Ching-Yuan Juan, Kaohsiung County (TW); Kuo-Chun Lin, Kaohsiung County (TW)

Correspondence Address: Joe McKinney Muncy, PO Box 1364, Fairfax, VA, 22038-1364, US

(21) Appl. No.: 11/783,231

(22) Filed: Apr. 6, 2007

(51) Int. Cl. H01J 7/24; H01J 7/26

(52) U.S. Cl. 313/36

(57) ABSTRACT

The present invention discloses an LED-lamp heat-dissipation device, which comprises LED lamps, an aluminum baseplate and a hollow heat-dissipation module. The hollow heat-dissipation module further comprises a hollow accommodation unit and a cooling fin unit, and the hollow accommodation unit has a plurality of heat-dissipation strips. The LED lamps are soldered on the aluminum baseplate. The aluminum baseplate together with the LED lamps is applied onto one side of the hollow heat-dissipation module; then liquid is filled into the hollow accommodation unit of the hollow heat-dissipation module. When the LED lamps are turned on, heat will be conducted to the aluminum baseplate and then conducted to the cooling fin unit via the liquid inside the hollow accommodation unit, which the aluminum baseplate is applied onto. Then, the cooling fin unit will dissipate heat out. Thereby, the present invention can achieve a fast heat-dissipation effect.

### FIELD OF THE INVENTION

The present invention relates to a heat-dissipation device, particularly to an LED-lamp heat-dissipation device.

### BACKGROUND OF THE INVENTION

Refer to FIG. 1. In a conventional LED-lamp heat-dissipation device, the LED lamps A10 are soldered on an aluminum baseplate A20. Via the superior thermal conductivity of aluminum, heat is thus fast dissipated. However, such a design has the drawbacks: when too many LED lamps A10 are soldered on the aluminum baseplate A20, the aluminum baseplate A20 is unlikely to dissipate all the heat, and the aluminum baseplate A20 will thus overheat; and the area of the aluminum baseplate A20 cannot be varied with the quantity of the LED lamps A10.

Refer to FIG. 2. To solve the abovementioned problems, a conventional technology integrates the aluminum baseplate A20, which has the LED lamps A10, with a cooling fin unit A30 via a single-side nickel electroplating. However, such a design has the drawbacks: when there is too much heat to be dissipated, the size of the cooling fin unit A30 is enlarged to enhance heat dissipation, which results in too massive a cooling fin unit A30; and the aluminum baseplate A20 is joined to the cooling fin unit A30 with nickel electroplating, which increases the cost.

### SUMMARY OF THE INVENTION

The primary objective of the present invention is to solve the conventional problem that LED lamps on an aluminum baseplate have poor heat dissipation and is to provide an LED-lamp heat-dissipation device, wherein a hollow heat-dissipation module is integrated with an aluminum baseplate, and liquid is filled into the hollow accommodation unit of the hollow heat-dissipation module to achieve fast heat dissipation.

To achieve the abovementioned objectives, the present invention proposes an LED-lamp heat-dissipation device, which comprises LED lamps, an aluminum baseplate and a hollow heat-dissipation module. One side of the hollow heat-dissipation module has a cooling fin unit, and the other side has a hollow accommodation unit. The interior of the hollow accommodation unit has a plurality of heat-dissipation strips. The LED lamps are soldered on the aluminum baseplate. The aluminum baseplate together with the LED lamps is applied onto the surface of the hollow accommodation unit on one side of the hollow heat-dissipation module; then liquid is filled into the hollow accommodation unit. When the LED lamps are turned on, heat will be conducted to the aluminum baseplate and then conducted to the cooling fin unit via the liquid inside the hollow accommodation unit, which the aluminum baseplate is applied onto. Then, the cooling fin unit of the hollow heat-dissipation module will dissipate heat out. Thereby, the present invention can achieve a fast heat-dissipation effect.

### BRIEF DESCRIPTION OF THE DRAWINGS

FIG. 1 is a perspective view showing the aluminum baseplate and LED lamps of a conventional heat-dissipation device.

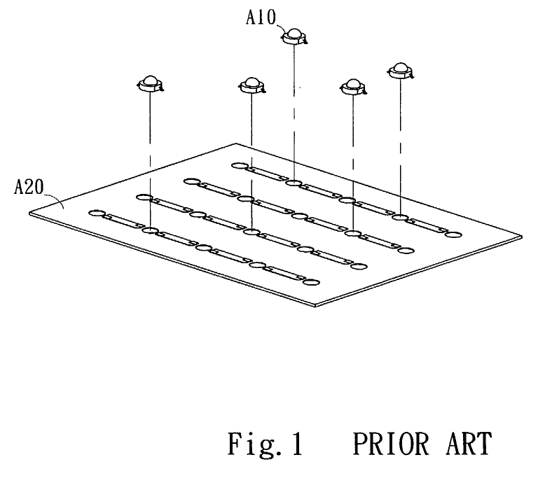

FIG. 2 is a perspective view showing the LED lamps soldered on an aluminum baseplate and the fin of a conventional heat-dissipation device.

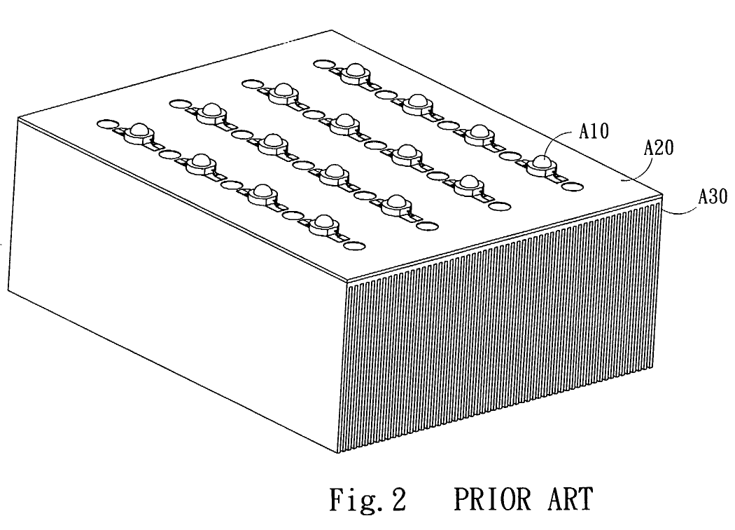

FIG. 3A is a perspective exploded view showing the LED-lamp heat-dissipation device according to the present invention.

FIG. 3B is a partially-enlarged view showing the LED-lamp heat-dissipation device according to the present invention.

FIG. 4 is a perspective view showing the assembly of the LED-lamp heat-dissipation device according to a first embodiment of the present invention.

FIG. 5 is a sectional view showing the LED-lamp heat-dissipation device according to the first embodiment of the present invention.

FIG. 6 is a perspective view showing the assembly of the LED-lamp heat-dissipation device according to a second embodiment of the present invention.

FIG. 7 is a sectional view showing the LED-lamp heat-dissipation device according to the second embodiment of the present invention.

FIG. 8 is a perspective view showing the LED-lamp heat-dissipation device according to the second embodiment of the present invention.

FIG. 9 is another perspective view showing the assembly of the LED-lamp heat-dissipation device according to the second embodiment of the present invention.

FIG. 10 is a perspective view showing the assembly of the LED-lamp heat-dissipation device according to a third embodiment of the present invention.

FIG. 11 is a sectional view showing the LED-lamp heat-dissipation device according to the third embodiment of the present invention.

### DETAILED DESCRIPTION OF THE PREFERRED EMBODIMENTS

Below, the appearances and characteristics of the present invention are described in detail in cooperation with the drawings.

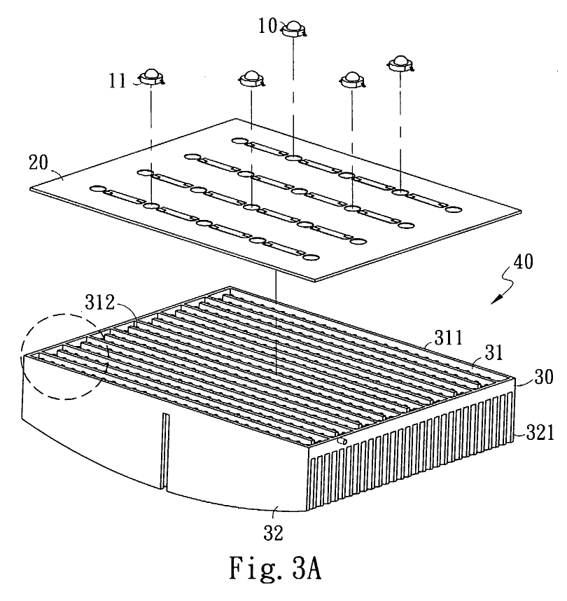

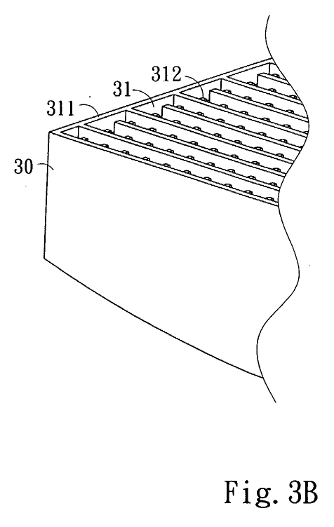

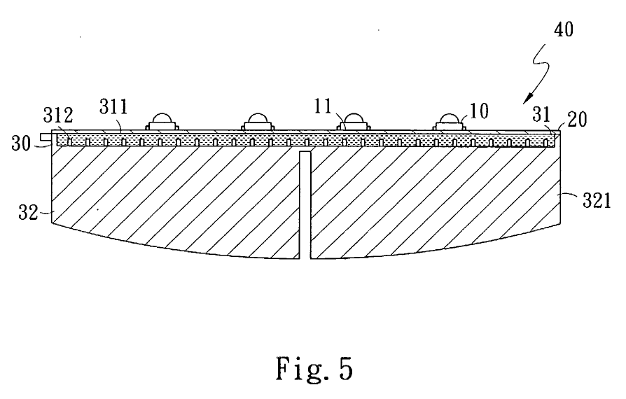

Refer to FIG. 3A, FIG. 3B and FIG. 5. The LED-lamp heat-dissipation device 40 of the present invention comprises the following components: LED lamps 10, an aluminum baseplate 20 and a hollow heat-dissipation module 30.

One side of the hollow heat-dissipation module 30 has a cooling fin unit 32 for heat dissipation, and the other side has a hollow accommodation unit 31, which is an one-piece part having interconnecting cells and contains liquid to fast conduct heat. The interior of the hollow accommodation unit 31 has a plurality of heat-dissipation strips 312 to increase the contact area between the liquid and the hollow accommodation unit 31 and then fast dissipate heat. The hollow heat-dissipation module 30 can be fabricated into various geometrical shapes according to requirements.

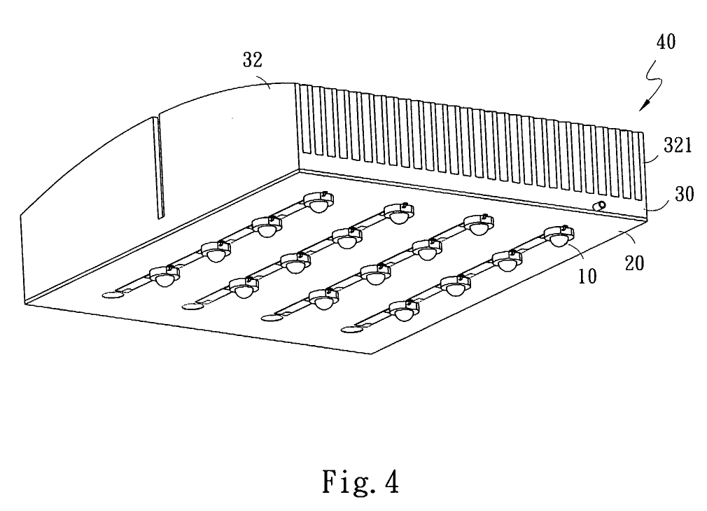

Refer to FIG. 4 and FIG. 5 for one embodiment of the present invention. In this embodiment, LED lamps 10 are soldered on the aluminum baseplate 20, and the heat source 11, which is on one side of each LED lamp 10, contacts the aluminum baseplate 20. The aluminum baseplate 20 together with the LED lamps 10 is applied onto the surface 311 of the hollow accommodation unit 31 on one side of the hollow heat-dissipation module 30; then liquid is filled into the hollow accommodation unit 31. When the LED lamps 10 are turned on, heat will be conducted to the aluminum baseplate 20 and then conducted to the cooling fin unit 32 via the liquid inside the hollow accommodation unit 31, which the aluminum baseplate 20 is applied onto. Then, the cooling fin unit 32 will dissipate heat out. Besides, the heat-dissipation strips 312 inside the hollow accommodation unit 31 increase the contact area between the liquid and the hollow accommodation unit 31 to promote heat-dissipation efficiency.

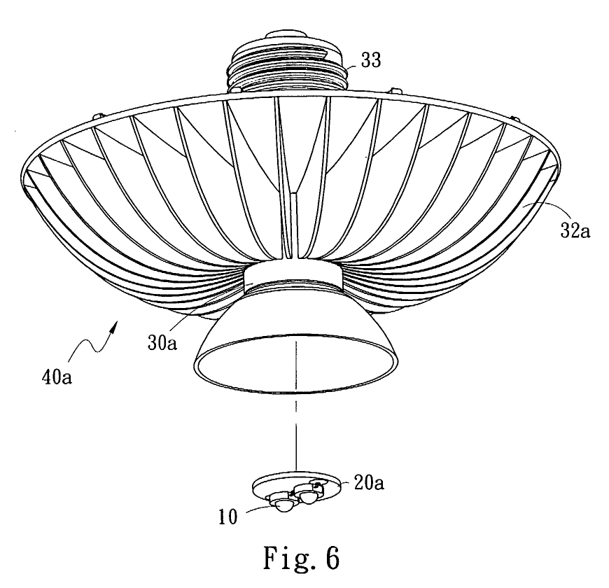

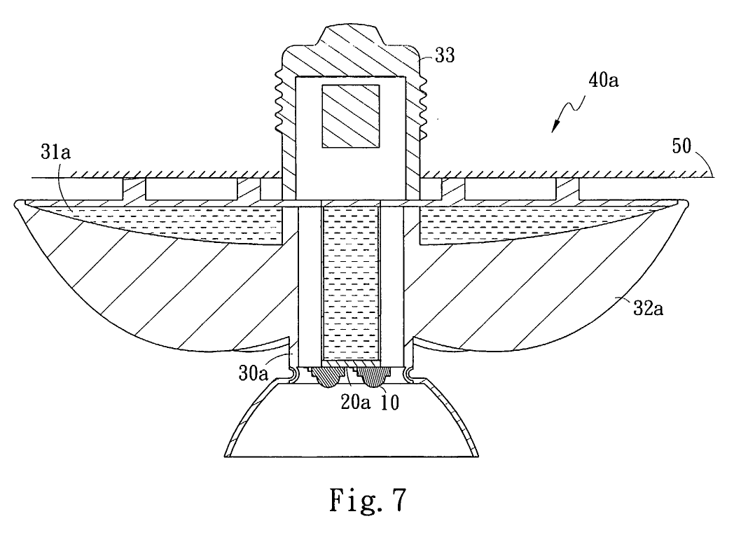

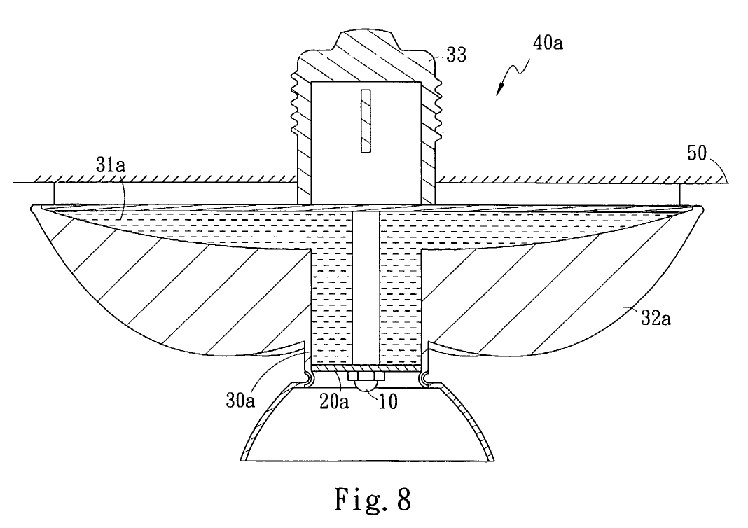

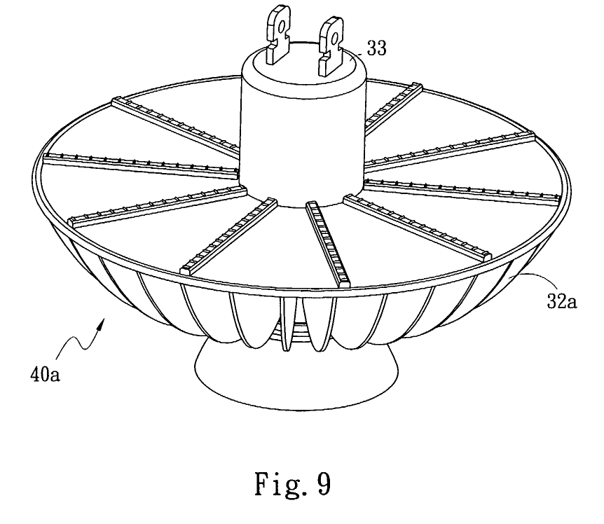

Refer to from FIG. 6 to FIG. 9 for another embodiment of the present invention. In this embodiment, the bottom of the hollow heat-dissipation module 30a has a fixing member 33 used to fix the LED-lamp heat-dissipation device 40a to a wall 50. The hollow accommodation unit 31a and the cooling fin unit 32a are fabricated into geometrical arc shapes to increase liquid-contacting area and heat-dissipation area. The aluminum baseplate 20a may have various geometrical shapes to meet the shape of the hollow heat-dissipation module 30a. Besides, the quantity and arrangement of the LED lamps 10 can be varied according to the size and shape of the aluminum baseplate 20a.

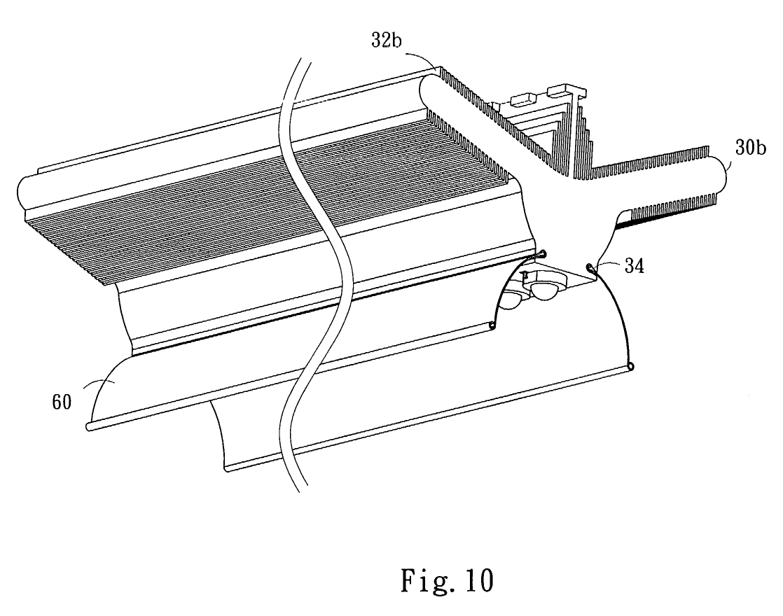

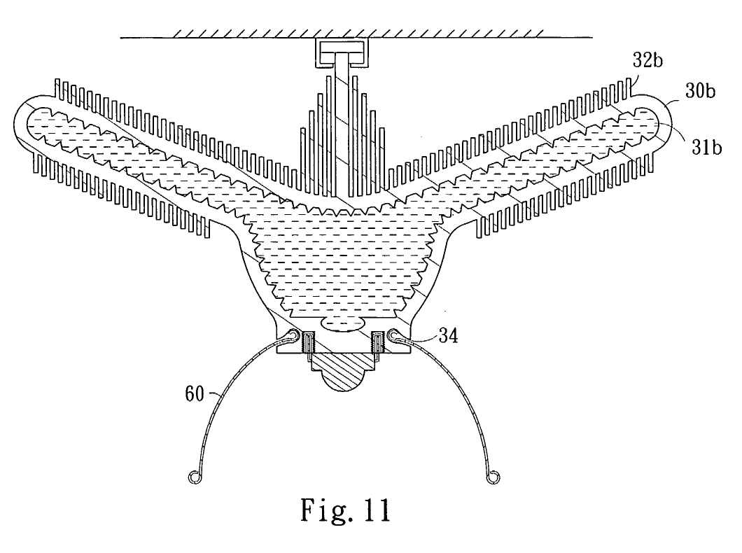

Refer to FIG. 10 and FIG. 11 for further another embodiment of the present invention. In this embodiment, the hollow heat-dissipation module 30b is fabricated with an aluminum extrusion technology; thereby, the heat transference from the hollow accommodation unit 31b to the cooling fin unit 32b can be more efficiently. Besides, the left and right sides of the heat-dissipation module 30b may have two trenches 34, into which two lamp covers 60 will be inserted.

What is claimed is:

1. An LED-lamp heat-dissipation device, comprising LED lamps, an aluminum baseplate and a hollow heat-dissipation module, wherein one side of said hollow heat-dissipation module has a cooling fin unit, and the other side has a hollow accommodation unit that is an one-piece part having interconnecting cells and containing liquid; said aluminum baseplate, on which said LED lamps are soldered, is applied onto the surface of said hollow accommodation unit on one side of said hollow heat-dissipation module.

2. The LED-lamp heat-dissipation device according to claim 1, wherein said hollow heat-dissipation module can be fabricated into various geometrical shapes according to requirements.

3. The LED-lamp heat-dissipation device according to claim 1, wherein said aluminum baseplate may have various geometrical shapes to meet the shape of said hollow heat-dissipation module.

4. The LED-lamp heat-dissipation device according to claim 1, wherein the quantity and arrangement of said LED lamps can be varied according to the size and shape of said aluminum baseplate.

5. The LED-lamp heat-dissipation device according to claim 1, wherein the interior of said hollow accommodation unit on one side of said hollow heat-dissipation module has a plurality of heat-dissipation strips to increase heat-dissipation efficiency.

6. The LED-lamp heat-dissipation device according to claim 1, wherein the bottom of said hollow heat-dissipation module has a fixing member used to fast fix said LED-lamp heat-dissipation device to a wall.
